(19) United States
(12) Patent Application Publication
(10) Pub. No.: US 2015/0067016 A1
(43) Pub. Date: Mar. 5, 2015

(54) METHOD FOR PLAYING CONTENTS ON AN ELECTRONIC DEVICE

(71) Applicant: Samsung Electronics Co., Ltd., Gyeonggi-do (KR)

(72) Inventors: Sung-Jae Park, Seoul (KR); Hyun-Geun Kim, Gyeonggi-do (KR); Jong-Cheol Seol, Gyeonggi-do (KR); Dong-Hee Yoo, Incheon (KR)

(21) Appl. No.: 14/474,801

(22) Filed: Sep. 2, 2014

(30) Foreign Application Priority Data
Aug. 30, 2013 (KR) 10-2013-0104405

(51) Int. Cl. H04L 29/08

(52) U.S. Cl. CPC H04L 67/1095
USPC 709/201

(57) ABSTRACT

An apparatus and method for playing content in an electronic device connected through a network are provided. The electronic device includes a communication unit for connecting with a master electronic device through a network, and at least one processor, wherein the processor is configured for receiving synchronization information from the master electronic device, and determining one of a content playing time point and a position of content to be played on the basis of a receive delay with respect to the master electronic device, and the synchronization information includes at least one of clock information of the master electronic device, position information of content played in the master electronic device, start delay information, which is a time of waiting until the content is played, and audio latency information, which is a time delayed until the content is output after the content is played in the master electronic device.

### PRIORITY

This application claims priority under 35 U.S.C. §119(a) to Korean Patent Application Serial No. 10-2013-0104405, which was filed in the Korean Intellectual Property Office on Aug. 30, 2013, the entire disclosure of which is incorporated herein by reference.

### BACKGROUND OF THE INVENTION

1. Field of the Invention

The present invention relates generally to a method for playing content on an electronic device, and more particularly, to a method in which electronic devices connected through a network can provide content at the same time point to each other.

2. Description of the Related Art

Electronic devices having a convergence function of complexly performing one or more functions have been increased in number in recent years. The electronic devices may be embodied as a mobile terminal, which may be in the form of a smart phone, in which case, the mobile terminal includes a touch-type display module with a large-sized screen and has a high-definition camera module, thereby allowing the mobile terminal to capture a still picture and a moving picture, in addition to a typical function such as communication. Further, the mobile terminal can play multimedia content such as a music, a video, and the like and can access a network to perform web surfing.

By employing a highly efficient process to perform the foregoing operations, the mobile terminal has been gradually evolved to perform various convergence functions at faster speeds and thus has been remarkably developed to an extent that a main function, i.e., communication with a peer user, is considered merely as an additional function.

In certain instances, the electronic device may configure a network with at least one neighboring electronic device, which co-exists in a specific space. In such an instance, the electronic device may share, transmit, and manage digital content (e.g., photos, music, video, etc.) with respect to the neighboring electronic device connected through the network. The sharing of the digital content may include playing the same content in a master electronic device and a slave electronic device. The digital content may include photos, music, videos, an e-book, a web page, and the like.

Some electronic device may configure a sharing group by configuring a network with at least one neighboring electronic device (i.e., a 2^{nd} electronic device) for sharing the digital content. Such electronic devices may play content together with electronic devices included in the sharing group in a state where the sharing group is configured. The electronic device may operate as a stream server for streaming digital content to the neighboring electronic device in the state where the sharing group is configured.

Although the electronic devices included in the sharing group play the same digital content, a playing position or a playing time point of the digital content may be different. For example, a 1^{st} electronic device which plays digital content and operates as a server may transmit information to 2^{nd} electronic devices, which are the remaining electronic devices belonging to the sharing group, so that the 2^{nd} electronic devices can play the transmitted information. However, due to a receive delay for the information, a content position or a playing time point may differ in the electronic devices belonging to the sharing group. As a result therefore, an audio latency may occur in the electronic devices, e.g., the 2^{nd} electronic device, until an actual sound is output after playing is has begun. The audio latency is different in each electronic device, and, thus, even if the playing is requested at the same time point, a content playing position or a playing time point of the electronic devices belonging to the sharing group may be different.

### SUMMARY OF THE INVENTION

The present invention has been designed to address at least the problems and/or disadvantages described above and to provide at least the advantages described below. Accordingly, an aspect of the present invention is to provide an apparatus and method in which electronic devices connected through a network provide content at the same time point.

Another aspect of the present invention is to provide an apparatus and method in which an electronic device plays content together with a master electronic device after a specific time is delayed.

Another aspect of the present invention is to provide an apparatus and method in which an electronic device defines a reference clock on the basis of a clock difference with respect to a master electronic device.

Another aspect of the present invention is to provide an apparatus and method in which an electronic device compensates for a content playing time point on the basis of a reference clock.

Another aspect of the present invention is to provide an apparatus and method in which an electronic device predicts a content playing position of a master electronic device on the basis of a reference clock.

In accordance with an aspect of the present invention, an electronic device is provided. The electronic device includes a communication unit for connecting with a master electronic device through a network, and at least one processor, wherein the at least one processor is configured for receiving synchronization information from the master electronic device, and determining one of a content playing time point and a position of content to be played on the basis of a receive delay with respect to the master electronic device, and the synchronization information includes at least one of clock information of the master electronic device, position information of content played in the master electronic device, start delay information, which is a time of waiting until the content is played, and audio latency information, which is a time delayed until the content is output after the content is played in the master electronic device.

In accordance with another aspect of the present invention, a method of playing content of an electronic device is provided. The method includes receiving clock information and start delay time information from a master electronic device, confirming a clock difference with respect to the master electronic device on the basis of the clock information, and compensating for the start delay time on the basis of the confirmed clock difference, and playing the content after the compensated start delay time.

In accordance with another aspect of the present invention, a computer readable recording medium is provided. The computer readable recording medium stores a program for performing receiving clock information and start delay time information from a master electronic device, for confirming a clock difference with respect to the master electronic device on the basis of the clock information, and for compensating for the start delay time on the basis of the confirmed clock different, and playing the content after the compensated start delay time.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a block diagram of an electronic device according to an embodiment of the present invention;

FIG. 2 is a diagram illustrating a processor according to an embodiment of the present invention;

FIG. 3 is a flowchart illustrating a content playing operation of an electronic device according to an embodiment of the present invention;

FIG. 4 is a flowchart illustrating a content playing operation of an electronic device according to an embodiment of the present invention;

FIG. 5 is a diagram illustrating an operation of defining a reference clock of an electronic device according to an embodiment of the present invention;

FIG. 6 is a flowchart illustrating an operation of predicting a content playing time point of an electronic device according to an embodiment of the present invention;

FIG. 7 is a flowchart illustrating a synchronization request operation of an electronic device according to an embodiment of the present invention;

FIG. 8 is a diagram illustrating a content playing operation of a sharing group according to an embodiment of the present invention;

FIGS. 9A-9D are diagrams illustrating an operation of an electronic device for playing content according to an embodiment of the present invention; and

FIG. 10 is a flowchart illustrating an operation of an electronic device according to an embodiment of the present invention.

### DETAILED DESCRIPTION OF EMBODIMENTS OF THE PRESENT INVENTION

Embodiments of the present invention will be described herein below with reference to the accompanying drawings. In the following description on various embodiments of the present invention, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

An electronic device described hereinafter may be one or more devices among a smart phone, a tablet Personal Computer (PC), a mobile phone, a video phone, an e-book reader, a desktop PC, a laptop PC, a netbook computer, a Personal Digital Assistant (PDA), a Portable Multimedia player (PMP), a MPEG-1 Audio Layer 3 (MP3) player, a mobile medical device, an electronic bracelet, an electronic necklace, an electronic accessory, a camera, a wearable device, an electronic clock, a wrist watch, a smart white appliance (e.g., a refrigerator, an air conditioner, a cleaner, an artificial intelligent robot, a TeleVision (TV), a Digital Video Disk (DVD) player, an audio, an oven, a microwave oven, a washing machine, an air purifier, an electronic picture frame, etc.), various medical devices (e.g., Magnetic Resonance Angiography (MRA), Magnetic Resonance Imaging (MRI), Computed Tomography (CR), imaging equipment, ultrasonic instrument, etc.), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, a car infotainment device, an electronic equipment for ship (e.g., a vessel navigation device, a gyro compass, etc.), avionics, a security device, an electronic costume, an electronic key, a camcorder, game consoles, a Head-Mounted Display (HMD), a flat panel display device, an electronic album, a furniture or a part of building/constructions including a communication function, an electronic board, an electronic signature receiving device, a projector, etc.

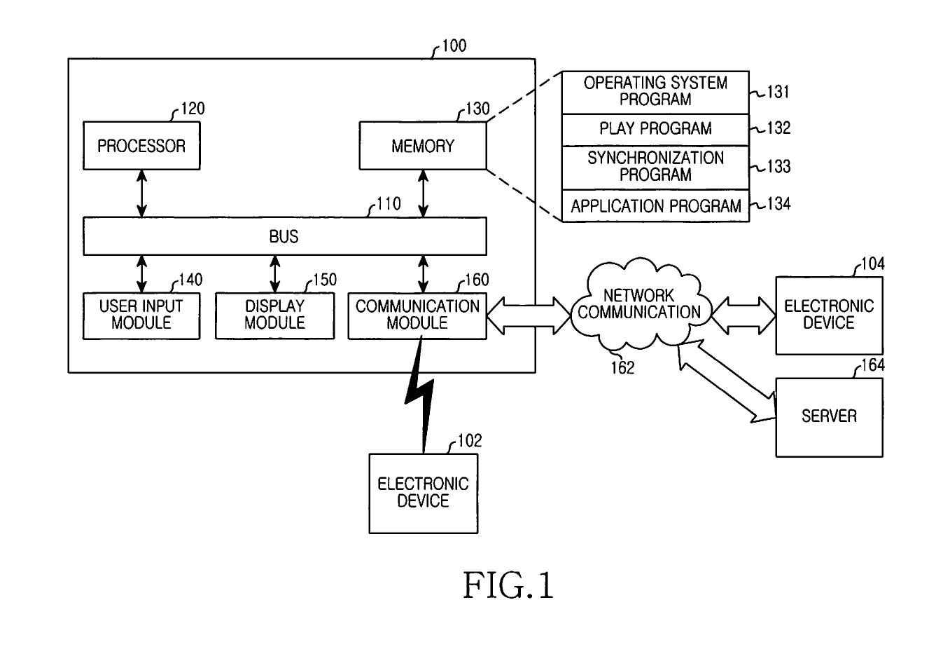

FIG. 1 is a block diagram of an electronic device according to an embodiment of the present invention.

Referring to FIG. 1, an electronic device 100 includes a bus 110, a processor 120, a memory 130, a user input module 140, a display module 150, and/or a communication module 160.

The bus 110 may be a circuit for connecting the aforementioned elements to each other and for delivering a communication (e.g., a control message) between the aforementioned elements.

The processor 120 receives an instruction from one or more of the aforementioned elements (e.g., the memory 130, the user input module 140, the display module 150, the communication module 160, etc.), for example, via the bus 110, and thus may interpret the received instruction and execute arithmetic or data processing according to the interpreted instruction.

The processor 120 controls an operation for content playing. According to an embodiment of the present invention, if the electronic device 100 operates as a master electronic device, the processor 120 sets a start delay time and delivers it to a slave electronic device together with clock information. If a synchronization request is received during the content playing, the processor 120 requests to pause the content playing to the slave electronic device, and thereafter transmits the synchronization request so that the content playing time point coincides.

If the electronic device 100 operates as the slave electronic device, the processor 120 compensates for a start delay time of the slave electronic device (i.e., a Slave's start Delay (SD)) by using a start delay time of the master electronic device (i.e., a Master's start Delay (MD)) and clock information included in the synchronization request. The processor 120 compensates for the start delay time of the slave electronic device by subtracting a receive delay time of the synchronization request, an audio latency time of the master electronic device (i.e., a master's audio latency), and an audio latency time of the slave electronic device (i.e., a slave's audio latency) from the start delay of the master electronic device.

The memory 130 stores an instruction or data received from the processor 120 and/or one of the other elements (e.g., the user input module 140, the display module 150, the communication module 160, etc.) or generated by the processor 120 or the other elements. The memory 130 includes programming modules, such as a kernel, a middleware, an Application Programming Interface (API), an application, and the like. Each of the aforementioned programming modules may consist of software, firmware, or hardware entities or may consist of at least two or more combinations thereof.

The kernel may control or manage the remaining other programming modules such as system resources (e.g., the bus, the processor, the memory, etc.) used to execute an operation or function implemented in the middleware, the API, or the application. The kernel may provide a controllable or manageable interface by accessing individual constitutional elements of the electronic device in the middleware, the API, or the application.

The middleware may perform a mediation role so that the API or the application communicates with the kernel to exchange data. Regarding task requests received from the application(s), the middleware may perform load balancing for the task request, for example, by using a method of assigning a priority (or the like) capable of using a system resource (e.g., the bus 110, the processor 120, the memory 130, etc.) of the electronic device 100 to at least one application among the application(s).

The API is an interface capable of controlling a function provided by the application in the kernel or the middleware, and may include, for example, at least one interface or function for file control, window control, video processing, or character control, and the like.

The memory 130 includes a program storage unit for storing a program for controlling an operation of the electronic device 100 and a data storage unit (not shown) for storing data generated during the program is executed.

For example, the data storage unit may store a variety of rewritable data, such as phonebook entries, outgoing messages, incoming messages, etc. and may store execution screen information for an application executed in the electronic device 100. The data storage unit may store a delay time (i.e., an audio latency) until an actual sound is output after a play request.

The program storage unit may include an operating system program 131, a play program 132, a synchronization program 133, and at least one application program 134.

The operating system program 131 includes various software components for controlling a general system operation. The control of the general system operation implies, for example, memory management and control, storage hardware (e.g., for a device(s)) control and management, power control and management, etc. The operating system program 131 also performs a function of facilitating communication between various hardware (e.g., for a device(s)) and program component (e.g., for a module(s)).

The play program 132 includes several types of software elements for playing content. The play program 132 includes a program for streaming content to be played to the slave electronic device and a client program for playing streaming content.

The synchronization program 133 includes several types of software elements for concurrently playing content of electronic devices indirectly connected through a network 162 or directly connected through local area communication. The synchronization program 133 defines a reference clock by calculating a clock difference between the master electronic device and the slave electronic device. The synchronization program 133 compensates for a content playing time point by using the reference clock. The clock may be a system clock among various clocks which run in the electronic device 100. The synchronization program 133 predicts a content playing time point of the master electronic device by using the reference clock. The synchronization program 133 compensates for a delay time (e.g., a start delay time which is a delay time until a time at which playing is called) received from the master electronic device on the basis of the reference clock. According to an embodiment of the present invention, if a difference between a content playing position of the master electronic device and a content playing position of the slave electronic device is greater than or equal to a threshold, the synchronization program 133 requests a synchronization process to the master electronic device.

The electronic device 100 may include an operation system module, a play module, a synchronization module, and the like. In such embodiments, an operation of each of the modules may be performed by the processor 120.

The user input module 140 receives an instruction or data, for example, from a user and delivers it to the processor 120 or the memory 130 via the bus 110.

The display module 150 displays a video, an image, data, and the like to the user.

The communication module 160 provides communication between another electronic device 102 (and/or electronic device 104) and the electronic device 100 or communication between a server 164 and the electronic device 100. The communication module 160 supports a specific local area communication protocol (e.g., Wireless Fidelity (WiFi), Bluetooth® (BT), Near Field Communication (NFC), or specific network communication 162 (e.g., Internet, Local Area Network (LAN), Wide Area Network (WAN), telecommunication network, cellular network, satellite network, Plain Old Telephone Service (POTS), etc.). Each of the electronic devices 102 and 104 may be a device which is the same (e.g., the same type) as the electronic device 100 or may be a different (e.g., a different type of) device. The communication module 160 transmits/receives a synchronization request including clock information, content information, delay information, and the like.

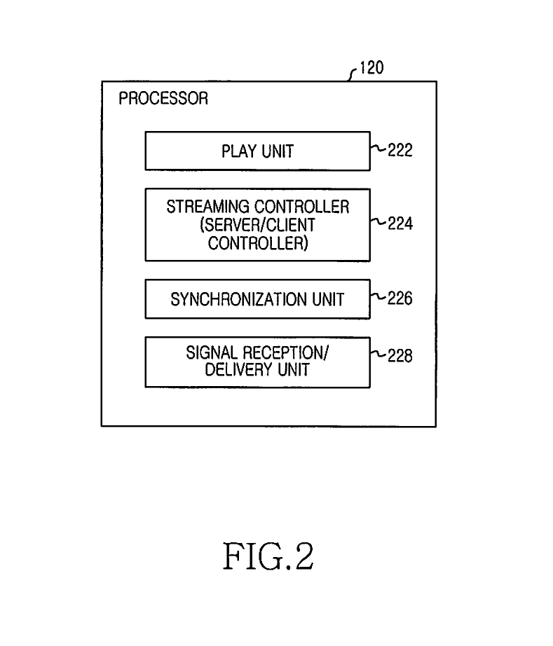

FIG. 2 is a diagram illustrating a processor according to an embodiment of the present invention.

Referring to FIG. 2, a processor 120 includes a play unit 222, a streaming controller 224, a synchronization unit 226, and a signal reception/delivery unit 228.

The play unit 222 controls an operation for playing content. The play unit 222 plays and outputs digital content stored in an electronic device, e.g., electronic devices 100, 102, and 104.

The streaming controller 224 performs a server operation for streaming content to be played to a slave electronic device and a client operation for playing streaming content.

The synchronization unit 226 plays content of electronic devices connected through a network at the same time point. The synchronization unit 226 defines a reference clock by calculating a clock difference between a master electronic device and the slave electronic device, which allows the synchronization unit 226 to compensate for a content playing time point by using the reference clock, thereby allowing the synchronization unit 226 to predict a content playing time point of the master electronic device by using the reference clock.

The synchronization unit 226 compensates for a delay time (e.g., a delay time until a time at which playing is called) received from the master electronic device on the basis of the reference clock and plays the content at a predicted time point. According to an embodiment of the present invention, if a difference between a content playing position of the master electronic device and a content playing position of the slave electronic device is greater than or equal to a threshold, the synchronization unit 226 requests a synchronization process to the master electronic device.

The signal reception/delivery unit 228 transmits/receives a synchronization request including clock information, content information, delay information, and the like.

According to an embodiment of the present invention, an electronic device includes a communication unit (e.g., communication module 160) for connecting with a master electronic device through a network and at least one processor (e.g., processor 120), wherein the at least one processor is configured for receiving synchronization information from the master electronic device and determining one of a content playing time point and a position of content to be played on the basis of a receive delay with respect to the master electronic device. The synchronization information includes at least one of clock information of the master electronic device, position information of content played in the master electronic device, start delay information, which is a time of waiting until the content is played, and audio latency information, which is a time delayed until the content is output after the content is played in the master electronic device.

The processor may confirm a receive delay on the basis of a clock difference with respect to the master electronic device.

The processor may compensate for the start delay time by using the receive delay and may synchronize a content playing time point on the basis of the compensated start delay time.

The processor may compensate for the start delay time on the basis of the receive delay and an audio latency time and may synchronize a content playing time point on the basis of the compensated start delay time.

The processor may predict a playing position of content played in the master electronic device by using the receive delay and may synchronize to the predicted content playing position.

The processor may predict a playing position of content played in the master electronic device by using the receive delay, and, if a difference to a current content playing position of the electronic device is greater than or equal to a threshold, the processor may request a synchronization to the master electronic device.

The processor may calculate a clock difference to a synchronization request reception time point by receiving a plurality of synchronization requests from the master electronic device and may define a smallest clock difference as a reference clock to be used when confirming the receive delay.

The processor may calculate the clock difference and compare the clock difference with the reference clock after defining the reference clock and may update a clock difference less than or equal to the reference clock to the reference clock.

The master electronic device may provide streaming content in a sharing group.

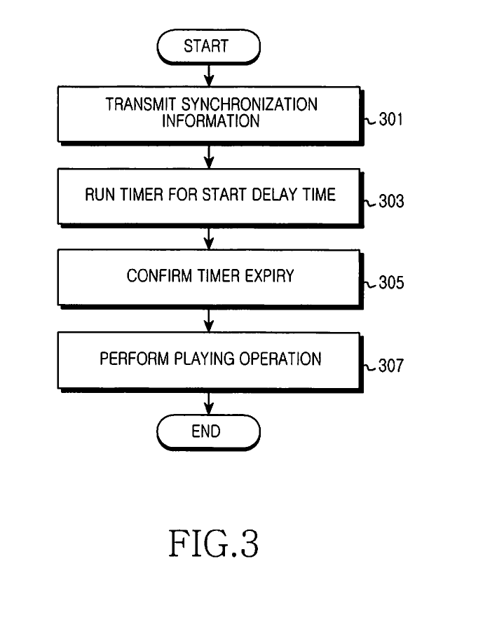

FIG. 3 is a flowchart illustrating a content playing operation of an electronic device according to an embodiment of the present invention.

The electronic device 100 shares digital content with at least one neighboring electronic device (e.g., electronic device 102, 104) by configuring a network. The electronic device 100 may be a master electronic device (i.e., a 1^{st} electronic device) for streaming the digital content in a state where a sharing group is configured. The remaining electronic devices (e.g., electronic device 102, 104) belonging to the sharing group may be slave electronic devices (e.g., 2^{nd} electronic devices). The digital content may include a variety of content that can be shared through the network, such as photos, music, videos, an e-book, a web page, and the like.

The 1^{st} electronic device and the 2^{nd} electronic device may call (or instruct) playing with a delay of a pre-defined time after a content play request is generated.

At step 301, the electronic device (i.e., the 1^{st} electronic device) generates a play request by transmitting synchronization information to the 2^{nd} electronic device belonging to the sharing group. The synchronization information includes content information, master electronic device's clock information, delay information, and the like. The 1^{st} electronic device plays streaming content together with the 2^{nd} electronic device, and the 1^{st} electronic device transmits content information including a playing position of content to be played, streaming content, and the like to the 2^{nd} electronic device. The 1^{st} electronic device designates and plays content stored in each of the 1^{st} and 2^{nd} electronic devices, and the 1^{st} electronic device transmits content information including a playing position of content to be played, a content name of the content to be played, and the like to the 2^{nd} electronic device. Delay information included in the synchronization information includes a start delay, which is a delay time until a time at which playing is called, and an audio latency, which is a delay time until an actual sound is output after the play request.

The 1^{st} electronic device transmits the synchronization information with a period corresponding to a pre-determined time. The 1^{st} electronic device transmits the synchronization information several times in a process before the digital content is processed, for example, if a sharing group is generated, during a pre-defined time.

At step 303, the 1^{st} electronic device runs a timer for a start delay time.

At step 305, the 1^{st} electronic device confirms an expiry of the timer for the start delay time. At step 307, after the expiry of the timer, the 1^{st} electronic device performs the content playing operation.

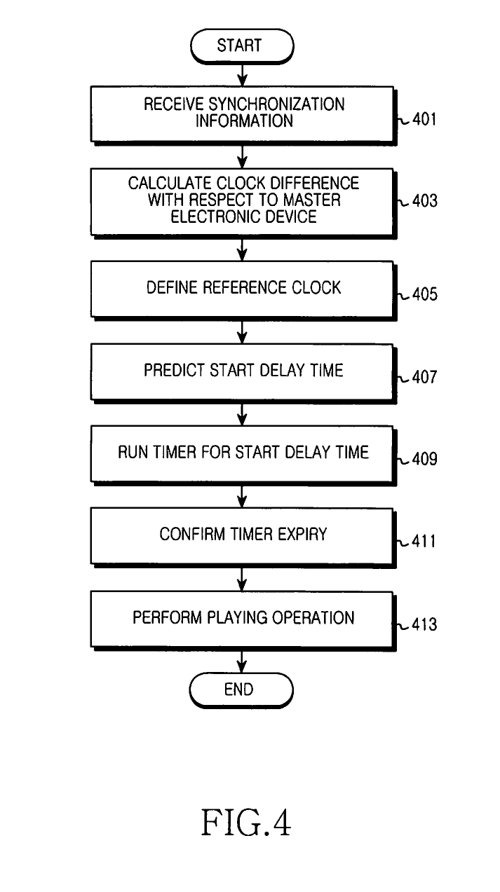

FIG. 4 is a flowchart illustrating a content playing operation of an electronic device according to an embodiment of the present invention.

Referring to FIG. 4, the electronic device may share digital content with at least one neighboring electronic device by configuring a network. The electronic device may be a 2^{nd} device for receiving digital content which is streamed from a master electronic device (i.e., a 1^{st} electronic device) in a state where a sharing group is configured.

The 1^{st} electronic device and the 2^{nd} electronic device may call (or instruct) playing with a delay of a pre-defined time or a predictable time, after a content play request is generated.

At step 401, the electronic device (i.e., the 2^{nd} electronic device) receives synchronization information from the 1^{st} electronic device belonging to the sharing group. The synchronization information includes content information, clock information, delay information (e.g., a start delay and an audio latency), and the like. The electronic device (i.e., the 2^{nd} electronic device) receives synchronization information, which is transmitted several times from the 1^{st} electronic device.

At step 403, the 2^{nd} electronic device calculates a clock difference with respect to the 1^{st} electronic device. The clock difference with respect to the 1^{st} electronic device is a difference between a 1^{st} electronic device's clock included in the synchronization information and a clock of the 2^{nd} electronic device and may imply a receive delay which varies depending on a network state.

At step 405, the 2^{nd} electronic device defines a reference clock on the basis of the clock difference with respect to the 1^{st} electronic device. The reference clock may be a clock difference between the 1^{st} electronic device (i.e., the master electronic device) and the 2^{nd} electronic device (i.e., the slave electronic device) in a situation where a receive delay is minimized. The 2^{nd} electronic device defines the reference clock by using a minimum value among the calculated clock differences with respect to the 1st electronic device.

At step 407, the 2^{nd} electronic device predicts and compensates for a start delay time. The 2^{nd} electronic device may call (or instruct) playing at the same time point as the 1^{st} electronic device by running a timer corresponding to the start delay time received from the 1^{st} electronic device. However, a playing time point may vary depending on a receive delay and an audio latency of each electronic device. The 2^{nd} electronic device compensates for the start delay time received from the 1^{st} electronic device on the basis of the receive delay and the audio latency. A start delay time of the 2^{nd} electronic device (i.e., a slave start delay) may be a time obtained by subtracting the receive delay and an audio latency time difference with the 1^{st} electronic device (i.e., a slave audio latency-a master audio latency) from a start delay time of the 1^{st} electronic device (i.e., a master start delay). At step 409, the 2^{nd} electronic device runs a timer for the compensated start delay time. Herein, the compensated start delay time may be a 2^{nd} electronic device's play calling time which is compensated so that the content is output at the same time point as a content output time point of the 1^{st} electronic device.

At step 411, the 2^{nd} electronic device confirms a timer expiry. At step 413, the 2^{nd} electronic device performs the content playing operation.

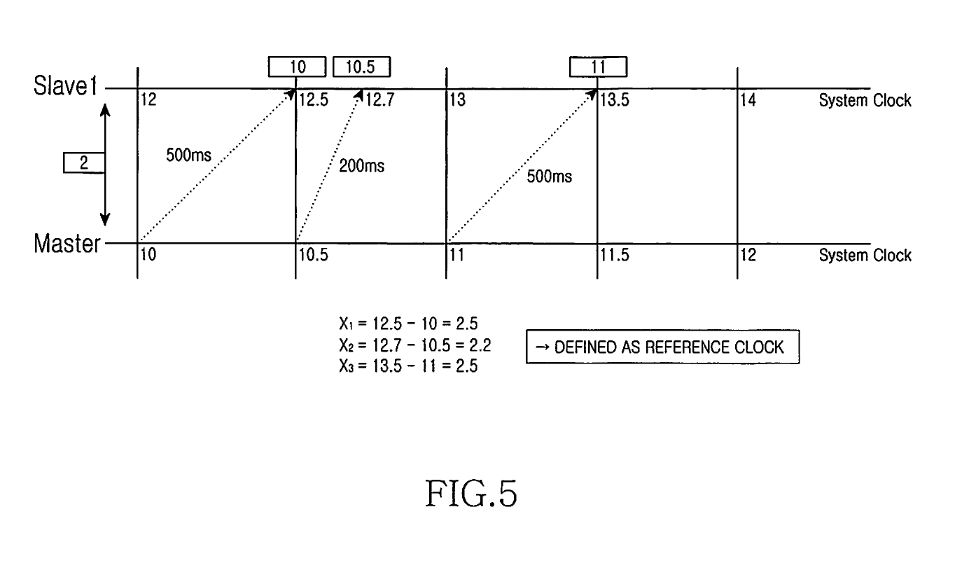

FIG. 5 is a diagram illustrating an operation of defining a reference clock of an electronic device according to an embodiment of the present invention.

Referring to FIG. 5, a master electronic device (i.e., a 1^{st} electronic device) and a slave electronic device (i.e., a 2^{nd} electronic device) may have different clocks.

The master electronic device transmits a play request to the slave electronic device so that content is played. The master electronic device defines a start delay time so that a playing time point coincides with the slave electronic device and provides it to the slave electronic device. The master electronic device and the slave electronic device wait for the start delay time and thereafter may transmit the play request so that the content is played.

A receive delay may occur between the master electronic device and the slave electronic device. The receive delay may be a network delay, which occurs on the basis of a network state. Upon receiving the start delay time in the state where the receive delay occurs, a play request time may be delayed by the receive delay in the slave electronic device.

The slave electronic device compensates for the start delay time on the basis of the receive delay. The receive delay may be confirmed on the basis of a clock difference between the two electronic devices. The slave electronic device calculates a clock difference on the basis of a transmission/reception clock at a time at which the start delay time is received and defines a smallest clock difference as a clock difference for a situation where a receive delay is minimized. The clock difference for a case where the receive delay is minimized may be stored by being defined as a reference clock.

A situation where the clock difference is calculated for each period by the slave electronic device is shown in the drawing in a situation where the master electronic device delivers a system clock to the slave electronic device in every 500 ms.

In the aforementioned situation, the slave electronic device confirms that a clock difference X1 of 2.5 ms is generated as to a 1^{st} system clock, a clock difference X2 of 2.2 ms is generated as to a 2^{nd} system clock, and a clock difference X3 of 2.5 ms is generated as to a 3^{rd} system clock.

It can be seen that a receive delay does not occur between the two electronic devices as the clock difference approaches to 0, and the slave electronic device may define a smallest clock difference as a reference clock. Although it can be confirmed in the drawing that an actual clock difference is 2 ms, it can be seen that the reference clock corresponding to 2.2 ms, which is similar to the clock difference, is calculated by using a minimum clock difference.

After defining the reference clock, the slave electronic device calculates a clock difference between the two electronic devices and compares the calculated clock difference with the reference clock.

If the calculated clock difference is less than the reference clock, the slave electronic device determines that the receive delay is decreased to be less than a minimum value and then updates it to the reference clock. According to an embodiment of the present invention, if the receive delay is decreased, the slave electronic device may run a timer corresponding to a start delay time received from the master electronic device so that content is played at the same time point as the master electronic device.

If the calculated clock difference is greater than the reference clock, the slave electronic device determines that a receive delay occurs and thus compensates for the start delay time received from the master electronic device by the clock difference and runs a timer corresponding to the compensated start delay time so that the content is played at the same time point as the master electronic device.

The slave electronic device receives the start delay time for 5 ms in a state where the reference clock is defined to 2.2 ms. According to an embodiment of the present invention, if the clock difference of 2.2 ms, which is the same as the reference clock, is confirmed at a time at which the start delay time is received, the slave electronic device plays the content after 5 ms. If a clock difference of 2.7 ms, which is further delayed from the reference clock at the time at which the start delay time, is received, the slave electronic device plays the content after 4.5 ms by shortening the start delay time received from the master electronic device.

The slave electronic device compensates for the start delay time either periodically or at a time at which the content is played initially or the content is paused and resumed.

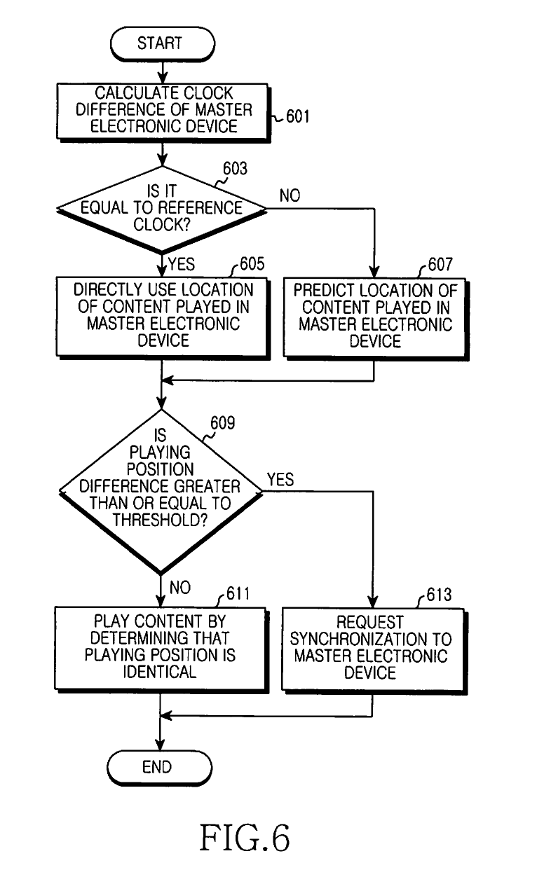

FIG. 6 is a flowchart illustrating an operation of predicting a content playing time point of an electronic device according to an embodiment of the present invention.

The electronic device shares digital content by configuring a network with at least one neighboring electronic device. In a state where a sharing group is configured, the electronic device may be a slave electronic device (i.e., a 2^{nd} electronic device) for receiving digital content which is streamed from a master electronic device (i.e., a 1^{st} electronic device). The 2^{nd} electronic device receives synchronization information with a period corresponding to a pre-defined time from the master electronic device. The synchronization information includes content information, clock information, delay information (e.g., a start delay and an audio latency), and the like.

At step 601, the electronic device (i.e., the slave electronic device) calculates a clock difference of the master electronic device.

At step 603, the 2^{nd} electronic device confirms whether the clock difference of the master electronic device is equal to a pre-defined reference clock. The reference clock may be a clock difference between the electronic device and the master electronic device for a situation where a receive delay is minimized. According to an embodiment of the present invention, if the two clocks are equal to each other, the 2^{nd} electronic device may determine that the receive delay does not occur with respect to the master electronic device. If the two clocks are not equal to each other, the 2^{nd} electronic device determines that the receive delay occurs with respect to the master electronic device.

At step 605, if the clock difference of the master electronic device is equal to the reference clock, the 2^{nd} electronic device maintains a content playing operation by using a playing position of the master electronic device. The 2^{nd} electronic device maintains an operation of playing digital content which is streamed from the master electronic device, without having to compensate for the content playing position.

At step 607, if the clock difference of the master electronic device is not equal to the reference clock, the 2^{nd} electronic device may predict a location of content which is currently played in the master electronic device. The 2^{nd} electronic device predicts the position of the content which is currently played in the master electronic device, by using a receive delay as a compensation value. If a playing position corresponding to 60 ms is received from the master electronic device in a state where the receive delay occurs about 1 ms, the 2^{nd} electronic device predicts that the master electronic device plays a location corresponding to 61 ms at a time at which synchronization information is received.

At step 609, the 2^{nd} electronic device confirms a difference between the predicted content position (i.e., a master electronic device's content position) and a slave electronic device' content position currently being played is greater than or equal to a threshold.

At step 611, if the difference of the content positions played in the two electronic devices is less than the threshold, the 2^{nd} electronic device determines that the content playing position is synchronized between the two electronic devices and may maintain a content playing operation.

At step 613, if the difference between the predicted content position and the location included in the synchronization information is greater than or equal to the threshold, the 2^{nd} electronic device requests the master electronic device to perform synchronization again.

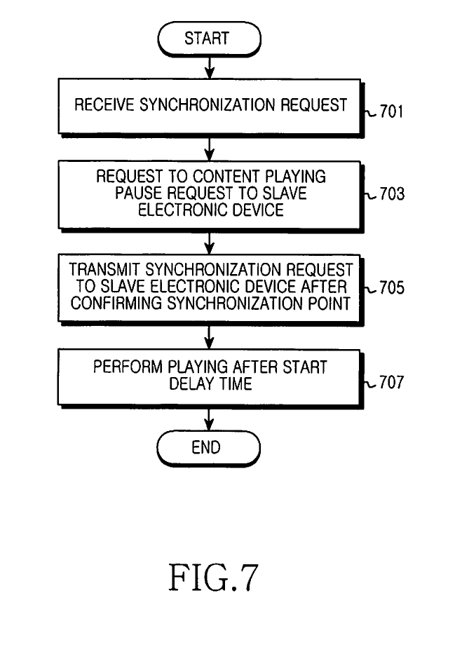

FIG. 7 is a flowchart illustrating a synchronization request operation of an electronic device according to an embodiment of the present invention.

Referring to FIG. 7, the electronic device may be a master electronic device (i.e., a 1^{st} electronic device) for streaming digital content in a state where a sharing group is configured. The remaining electronic devices belonging to the sharing group may be slave electronic devices (e.g., 2^{nd} electronic devices).

At step 701, the 1^{st} electronic device (i.e., the master electronic device) receives a synchronization request from the slave electronic device while playing the content by configuring the shared group. Herein, the synchronization request may be transmitted by the slave electronic device which determines that a content playing position of the master electronic device is different among electronic devices belonging to the sharing group.

At step 703, the 1^{st} electronic device transmits a content playing pause request to the slave electronic devices belonging to the sharing group.

At step 705, the 1^{st} electronic device confirms a synchronization point and thereafter transmits a request for synchronizing to the confirmed point to the slave electronic devices. The synchronization request includes a synchronization point of content to be played, delay information (e.g., start delay time information, audio latency time information), clock information, and the like. The 1^{st} electronic device determines the synchronization point to a playing position of a time at which the synchronization request is received from the slave electronic device.

At step 707, the 1^{st} electronic device plays the content after the start delay time.

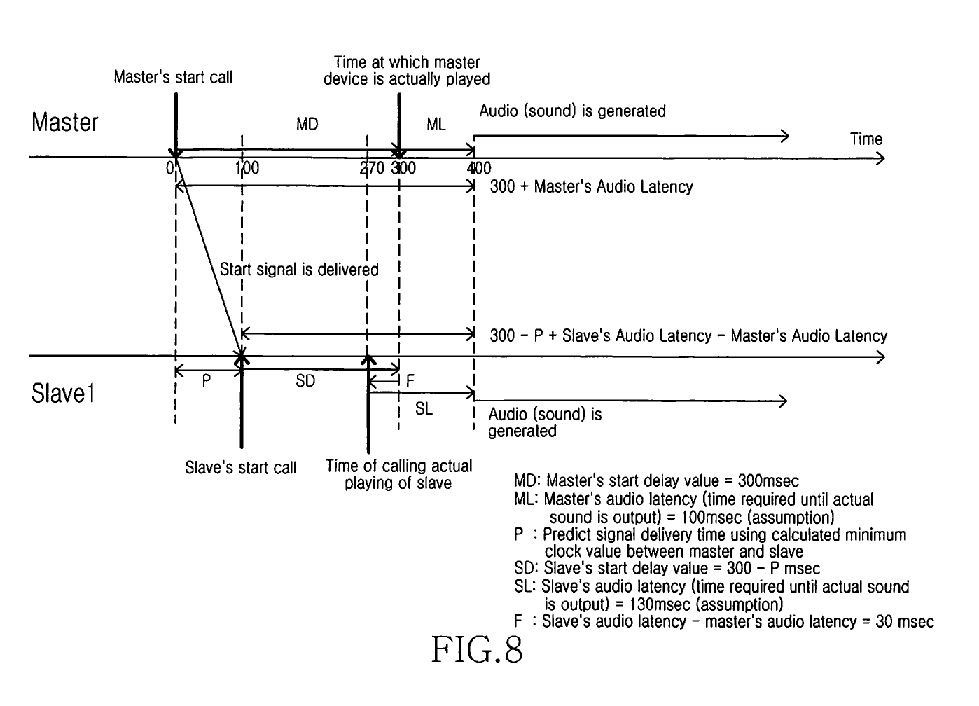

FIG. 8 is a diagram illustrates a content playing operation of a sharing group according to an embodiment of the present invention.

Referring to FIG. 8, the sharing group may consist of a master electronic device and at least one slave electronic device.

The master electronic device transmits synchronization information including clock information, delay information (e.g., start delay time information, audio latency time information), and the like from the slave electronic device. According to an embodiment of the present invention, the synchronization information may be transmitted in an initial content playing process. According to another embodiment, the synchronization information may be transmitted in a process of playing content which is paused while being played. According to yet another embodiment, the synchronization information may be transmitted periodically during a playing process.

If the master electronic device detects a start call as illustrated, a start signal may be delivered to the slave electronic device and playing requested after waiting for a start delay time from a time at which the start signal is delivered. When a touch input for a play menu is detected, the master electronic device delivers the start signal. The play request may be calling of an application for content playing.

After the play request, the master electronic device outputs the content when an audio latency time is elapsed.

In the FIG. 8, a content output time point of the master electronic device may be a sum of a start delay time of the master electronic device (i.e., Master's start delay (MD)) and an audio latency time thereof (i.e., Master's audio latency (ML)). Also, MD is 300 ms and ML is 100 ms. Therefore, the content output time point of the master electronic device may be a point of which a time is elapsed by 400 ms after the start call is detected.

The slave electronic device plays the content after the start delay time received from the master electronic device.

A receive delay occurs when the slave electronic device receives the start signal. A start signal transmission time point of the master electronic device and a start signal reception time point of the slave electronic device may be different due to the receive delay. The slave electronic device compensates for the start delay time on the basis of the receive delay time of the start signal and the slave electronic device's audio latency time, so that it is equal to a content output time point of the master electronic device.

In the FIG. 8, a content output time point of the slave electronic device may be a time point obtained by subtracting a difference F between a master's audio latency and a Slave's audio Latency (SL) (i.e., F=slave audio latency−master audio latency) from a start delay time of the master electronic device (i.e., a Master's start delay (MD)). Also, P is 100 ms and a difference between ML and SL is 30 ms. Therefore, the start delay time of the slave electronic device (i.e., Slave's start Delay (SD)) may be a duration of 170 ms after the start call is received. Moreover, the time point at which 170 ms is elapsed after the start call is received may be a time point at which 270 ms is elapsed after the start call is detected in the master electronic device. However, since the audio latency time of the slave electronic device is 130 ms, content may be output at the same time point as the master electronic device.

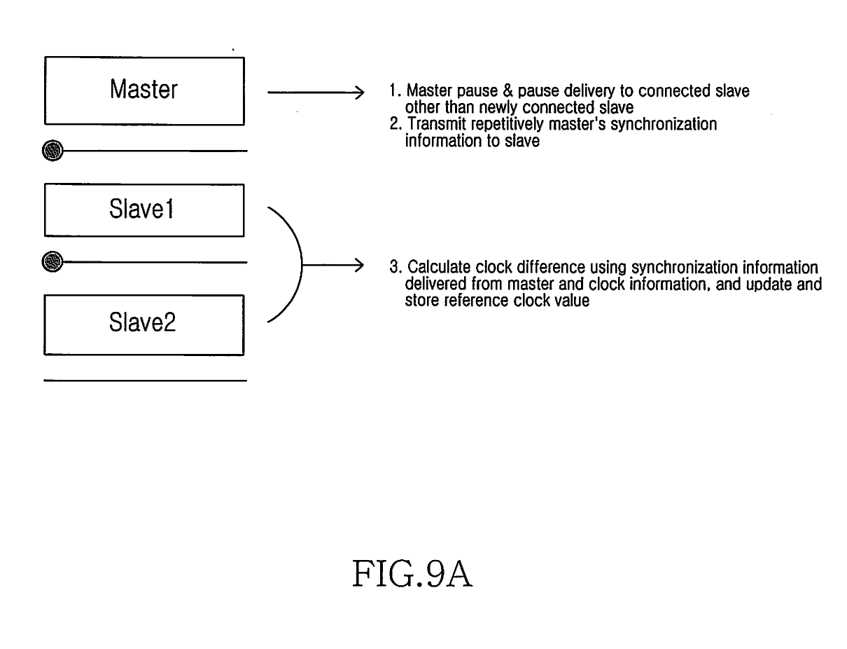

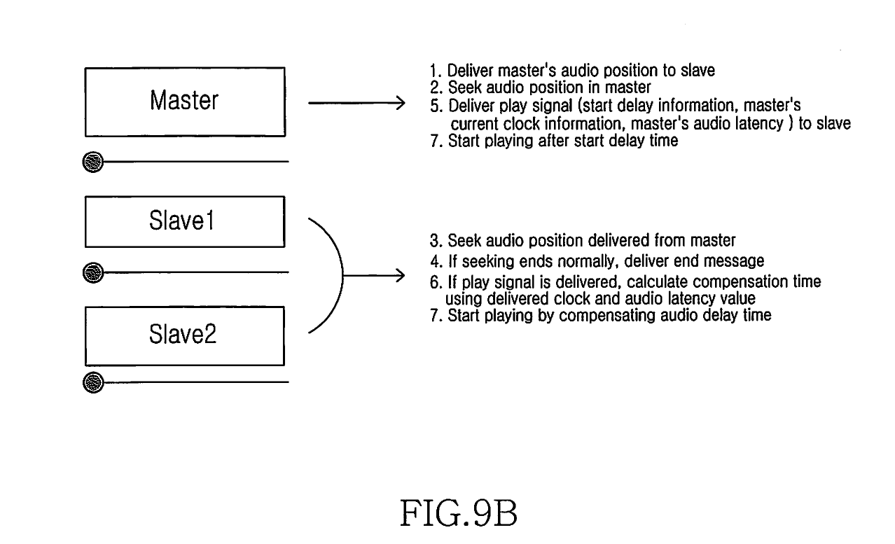

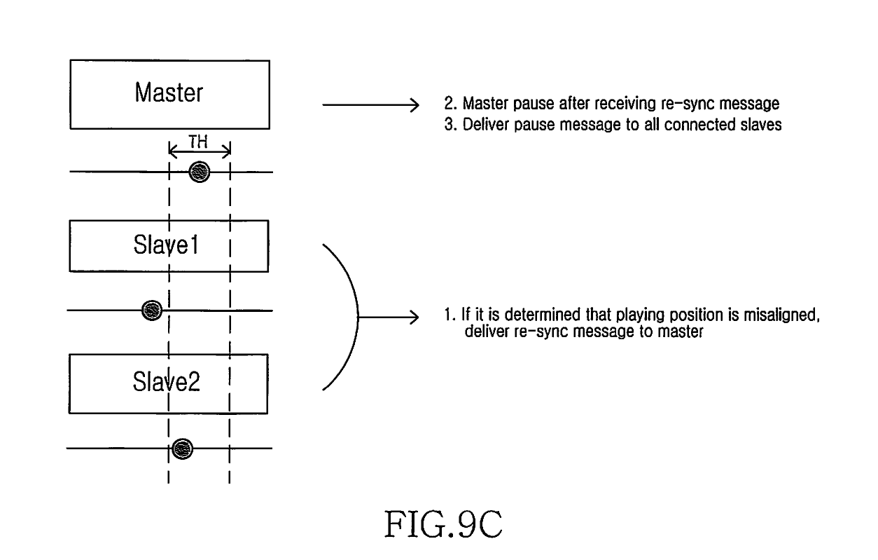

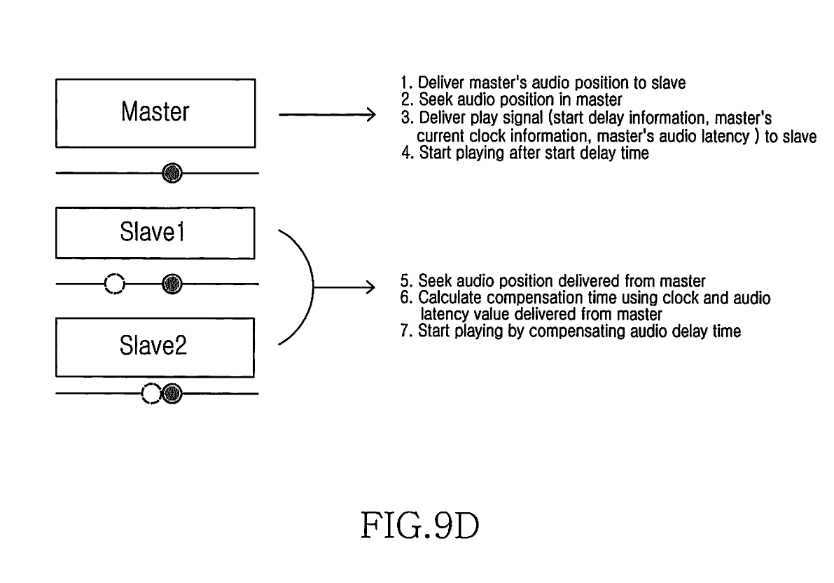

FIGS. 9A-9D are diagrams illustrating an operation of an electronic device for playing content according to an embodiment of the present invention.

FIG. 9A illustrates a situation where a slave electronic device 2 (i.e., a slave 2) participates in a group in a state where a master electronic device and a slave electronic device 1 (i.e., a slave 1) configure a sharing group.

When the participating of the salve electronic device 2 is confirmed, the master electronic device instructs to pause the playing of the content to the slave electronic device and thereafter transmits synchronization information to the slave electronic devices 1 and 2.

The slave electronic devices 1 and 2 calculate a clock difference by using the synchronization information delivered from the master electronic device and clock information thereof and may update a reference clock value by using a minimum clock difference.

FIG. 9B illustrates a situation where content is played by a master electronic device and a slave electronic device.

The master electronic device which intends to play the content may deliver a playing position of the content to slave electronic devices 1 and 2 and may seek the playing position of the content.

Upon receiving the playing position of the content, the slave electronic devices 1 and 2 search the received playing position of the content and deliver the result of the seeking to the master electronic device.

Upon receiving the result of the searching, the master electronic device delivers a start signal to the slave electronic devices 1 and 2. The start signal includes a start delay time, clock information, master electronic device's audio latency time information, and the like.

Upon receiving the start signal, the slave electronic devices 1 and 2 calculate a receive delay of the start signal by using clock information and compensate for a start delay time of the master electronic device by using a difference between an audio latency time of the master electronic device and an audio latency time of the slave electronic device.

FIG. 9C illustrates a situation where a slave electronic device transmits a synchronization request. It can be confirmed that a content playing position of a slave electronic device 1 is different from a content playing position of a master electronic device.

The master electronic device which plays the content may deliver a playing position, clock information, and the like to slave electronic devices 1 and 2 with an interval of a predetermined period.

The slave electronic device predicts a current content playing position of the master electronic device on the basis of the clock information. If the content playing position of the master electronic device is different from its content playing position by more than a determined threshold, the slave electronic device requests synchronization to the master electronic device.

Upon receiving the synchronization request, the master electronic device pauses the content playing and instructs the slave electronic device to pause the content playing.

FIG. 9D illustrates a situation where content playing is resumed by a master electronic device and a slave electronic device.

The master electronic device which intends to resume the content playing delivers a content playing position to slave electronic devices 1 and 2, and searches the content playing position.

Upon receiving the content playing position, the slave electronic devices 1 and 2 search the received content playing position and deliver the result of the searching to the master electronic device.

Upon receiving the result of the searching, the master electronic device delivers a start signal to the slave electronic devices 1 and 2. The start signal includes a start delay time, clock information, master electronic device's audio latency time information, and the like.

Upon receiving the start signal, the slave electronic devices 1 and 2 calculate a receive delay of the start signal by using clock information and compensate for a start delay time of the master electronic device by using a difference between an audio latency time of the master electronic device and an audio latency time of the slave electronic device.

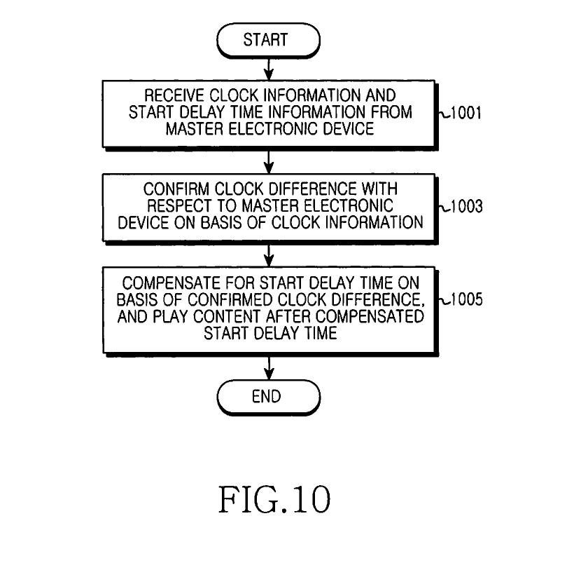

FIG. 10 is a flowchart illustrating an operation of an electronic device according to an embodiment of the present invention.

Referring to FIG. 10, at step 1001, the electronic device receives clock information and start delay time information from a master electronic device.

At step 1003, the electronic device confirms a clock difference with respect to the master electronic device on the basis of the clock information.

At step 1005, the electronic device compensates for the start delay time on the basis of the confirmed clock difference and plays the content after the compensated start delay time.

According to an embodiment of the present invention, the operation of compensating for the start delay time includes an operation of subtracting the clock difference from the received start delay time.

According to an embodiment of the present invention, the operation of compensating for the start delay time includes an operation of receiving audio latency time information from the master electronic device, an operation of calculating an audio latency time difference between the master electronic device and the electronic device, and an operation of subtracting the clock difference and the audio latency time different from the received playing time information.

According to an embodiment of the present invention, the operation of the electronic device includes an operation of, after the playing of the content, receiving clock information and position information of the content to be played with a period of a pre-defined time and an operation of predicting a position of the content played in the master electronic device at a time at which the position information of the content is received.

According to an embodiment of the present invention, the operation of the electronic device includes an operation of comparing the predicted content playing position of the master electronic device and the content playing position of the electronic device, and if a difference of the content playing positions is less than a threshold between the two electronic devices, an operation of playing the content without compensating for the playing position.

According to an embodiment of the present invention, the operation of the electronic device includes an operation of comparing the predicted content playing position of the master electronic device and the content playing position of the electronic device, and if a difference of the content playing positions is greater than or equal to a threshold between the two electronic devices, an operation of requesting a synchronization to the master electronic device.

According to an embodiment of the present invention, the operation of the electronic device includes an operation of synchronizing the content playing position on the basis of the content playing position of the master electronic device if a synchronization request is received after the playing of the content, and an operation of synchronizing the playing time point for the synchronized content playing position.

According to an embodiment of the present invention, the content may include at least one of photos, music, videos, an e-book, and a web page.

According to an embodiment, of the present invention at least some parts of a device (e.g., modules or functions thereof) or method (e.g., operations) of the present invention may be implemented with an instruction stored in a computer-readable storage media for example. If the instruction is executed by one or more processors (e.g., the processor 120), the one or more processors may perform a function corresponding to the instruction. The computer-readable storage media may be, for example, the memory 130. At least some parts of the programming module may be implemented (e.g., executed), for example, by the processor 120. At least some parts of the programming module may include modules, programs, routines, sets of instructions, processes, and the like, for performing one or more functions.

The computer readable recording medium may be a hardware device configured particularly to store and perform a program instruction (e.g., program module), for example, a hard disk, a magnetic medium such as a floppy disc and a magnetic tape, an optical storage medium such as a Compact Disc-ROM (CD-ROM) or a Digital Versatile Disc (DVD), a magnetic-optic medium such as a floptical disc, a Read Only Memory (ROM), a Random Access Memory (RAM), a flash memory, and the like. An example of the program instruction includes not only a machine language created by a compiler but also a high-level language executable by a computer by using an interpreter or the like. The aforementioned hardware device may be configured to operate as one or more software modules to perform the operation of the present invention, and vice versa.

The module or programming module according to the present invention may further include at least one or more components among the aforementioned components, or may omit some of them, or may further include additional other components. Operations performed by a module, programming module, or other components of the present invention may be executed in a sequential, parallel, repetitive, or heuristic manner. In addition, some of the operations may be executed in a different order or may be omitted, or other operations may be added.

According to an embodiment of the present invention, in a storage medium having instructions stored therein, when the instructions are executed by at least one processor, the processor is configured to perform at least one operation. The at least one operation includes receiving clock information and start delay time information from a master electronic device, confirming a clock difference with respect to the master electronic device on the basis of the clock information, and compensating for the start delay time on the basis of the confirmed clock different, and playing the content after the compensated start delay time.

According to an embodiment of the present invention, the at least one operation may further include comparing the content playing position of the master electronic device and the content playing position of the electronic device, and if a difference of the content playing positions is less than a threshold between the two electronic devices, playing the content without compensating for the playing position.

According to an embodiment, of the present invention the at least one operation may further include comparing the content playing position of the master electronic device and the content playing position of the electronic device, and if a difference of the content playing positions is greater than or equal to a threshold between the two electronic devices, requesting a synchronization to the master electronic device.

According to an embodiment of the present invention, an electronic device predicts a playing time point and a playing position on the basis of a clock difference between electronic devices connected with a network, so that the connected electronic devices can play content at the same time point.

While the present invention has been particularly shown and described with reference to certain embodiments thereof, it will be understood by those of ordinary skill in the art that various changes in form and detail may be made therein without departing from the spirit and scope of the present invention as defined by the following claims and their equivalents.

What is claimed is:

1. An electronic device comprising:
a communication unit for connecting with a master electronic device through a network; and
at least one processor;
wherein the at least one processor is configured to receive synchronization information from the master electronic device and determine one of a content playing time point and a position of content to be played using a receive delay with respect to the master electronic device, and
wherein the synchronization information includes at least one of clock information of the master electronic device, position information of content played in the master electronic device, start delay information, which is a time of waiting until the content is played, and audio latency information, which is a time delayed until the content is output after the content is played in the master electronic device.

2. The electronic device of claim 1, wherein the at least one processor is configured to confirm the receive delay on the basis of a clock difference with respect to the master electronic device.

3. The electronic device of claim 1, wherein the at least one processor is configured to compensate for the start delay time by using the receive delay and to synchronize a content playing time point on the basis of the compensated start delay time.

4. The electronic device of claim 1, wherein the at least one processor is configured to compensate for the start delay time on the basis of the receive delay and an audio latency time, and to synchronize a content playing time point on the basis of the compensated start delay time.

5. The electronic device of claim 1, wherein the at least one processor is configured to predict a playing position of content played in the master electronic device by using the receive delay, and to synchronize to the predicted content playing position.

6. The electronic device of claim 1, wherein the at least one processor is configured to predict a playing position of content played in the master electronic device by using the receive delay, and, if a difference to a current content playing position of the electronic device is greater than or equal to a threshold, to request a synchronization to the master electronic device.

7. The electronic device of claim 2, wherein the at least one processor is configured to calculate a clock difference to a synchronization request reception time point by receiving a plurality of synchronization requests from the master electronic device, and to define a smallest clock difference as a reference clock to be used when confirming the receive delay.

8. The electronic device of claim 7, wherein the at least one processor is configured to, after defining the reference clock, calculate the clock difference and compare the clock difference with the reference clock, and to update a clock difference less than or equal to the reference clock to the reference clock.

9. The electronic device of claim 1, wherein the master electronic device is configured to provide streaming content in a sharing group.

10. A method of playing content of an electronic device, the method comprising:
receiving clock information and start delay time information from a master electronic device;
confirming a clock difference with respect to the master electronic device on the basis of the clock information; and
compensating for the start delay time on the basis of the confirmed clock difference, and playing the content after the compensated start delay time.

11. The method of claim 10, wherein compensating for the start delay time comprises subtracting the clock difference from the received start delay time.

12. The method of claim 10, wherein compensating for the start delay time comprises:
receiving audio latency time information from the master electronic device;
calculating an audio latency time difference between the master electronic device and the electronic device; and
subtracting the clock difference and the audio latency time different from the received playing time information.

13. The method of claim 10, further comprising:
after playing the content, receiving clock information and position information of the content to be played with a period of a pre-defined time; and
predicting a position of the content played in the master electronic device at a time at which the position information of the content is received.

14. The method of claim 13, further comprising:
comparing the predicted content playing position of the master electronic device with the content playing position of the electronic device; and
if a difference of the content playing positions is less than a threshold between the two electronic devices, playing the content without compensating for the playing position.

15. The method of claim 13, further comprising:
comparing the predicted content playing position of the master electronic device with the content playing position of the electronic device; and
if a difference of the content playing positions is greater than or equal to a threshold between the two electronic devices, requesting a synchronization to the master electronic device.

16. The method of claim 10, further comprising:
if a synchronization request is received after the playing of the content, synchronizing the content playing position on the basis of the content playing position of the master electronic device; and
synchronizing the playing time point for the synchronized content playing position.

17. The method of claim 10, wherein the content includes at least one of photos, music, videos, an e-book, and a web page.

18. A computer readable recording medium for storing a program for performing:
receiving clock information and start delay time information from a master electronic device;
confirming a clock difference with respect to the master electronic device on the basis of the clock information; and
compensating for the start delay time on the basis of the confirmed clock different, and playing the content after the compensated start delay time.

19. The computer readable recording medium of claim 18, wherein the program performs comparing the content playing position of the master electronic device with the content playing position of the electronic device, and if a difference of the content playing positions is less than a threshold between the two electronic devices, playing the content without compensating for the playing position.

20. The computer readable recording medium of claim 18, wherein the program performs comparing the content playing position of the master electronic device with the content playing position of the electronic device, and if a difference of the content playing positions is greater than or equal to a threshold between the two electronic devices, requesting a synchronization to the master electronic device.
